(19) United States
(12) Patent Application Publication
(10) Pub. No.: US 2013/0220158 A1
(43) Pub. Date: Aug. 29, 2013

(54) SYSTEM AND A METHOD FOR DETECTING MATERIAL PARAMETERS

(71) Applicants: Vessen Vassilev, Lindome (SE); Borys Stoew, Gothenburg (SE); Gert Andersson, Lindome (SE); Jakob Blomgren, Kungalv (SE)

(72) Inventors: Vessen Vassilev, Lindome (SE); Borys Stoew, Gothenburg (SE); Gert Andersson, Lindome (SE); Jakob Blomgren, Kungalv (SE)

(73) Assignee: IMEGO AKTIEBOLAG, Gothenburg (SE)

(21) Appl. No.: 13/881,095

(22) PCT Filed: Oct. 28, 2011
(86) PCT No.: PCT/SE2011/051291

§ 371 Date: May 16, 2013

(30) Foreign Application Priority Data
Oct. 28, 2010 (SE) 1051127-7

(51) Int. Cl. G01N 21/86; B41F 23/02

(52) U.S. Cl. CPC G01N 21/86; B41F 23/02
USPC 101/484; 73/73

(57) ABSTRACT

A detecting unit is provided, including a transmitter arranged to emit electromagnetic radiation, having a frequency in the range of 0.1 to 10 THz, towards a paper web moving in a printing unit; a receiver arranged to receive electromagnetic radiation being transmitted through or reflected by the paper web and to create a signal representing the received radiation; and a controller having an input channel for receiving the signal and a calculating unit for determining a measure relating to the properties of the paper web from the signal.

### FIELD OF THE INVENTION

The present invention relates to a system and a method for detecting the water content of a paper web in a printing unit.

### PRIOR ART

Different systems and methods are provided for measuring and regulating parameters of paper based materials, such as paper webs used in printing units. In a printing press, water or water based solution is added to the paper web for increasing the printing quality of the unit. The printing performance is dependent on the water content of the printing web, and the water content should thus be optimized during the printing process. The water content of the paper web is also critical for other purposes; since the paper web may become unstable if the water content is too high it is necessary to monitor the water content of the paper web in order to avoid physical damage to the paper web.

A printing unit typically provides water based solution to the paper web at positions adjacent to the ink supplying units. For example, a printing unit may have four different ink supplies for providing each one of C, M, Y, and K colors, respectively. Consequently, four different stations for regulating the water content of the paper web may be used. Traditionally, such stations are controlled manually and the resulting printing quality is thus highly dependent on the skills of the individual operator.

However, systems have been proposed in which a detector may be used for each regulating station in order to measure the water content of the moving paper web. Such detectors are based on either microwave radiation or IR radiation.

A microwave method based on a transmitter and a receiver operating at microwave frequencies (couple of GHz) is known in the art. However the water absorbance is rapidly decreasing for frequencies below 50 GHz. In addition typical paper thickness of 80 um is very thin compared to the wavelength (100 mm at 3 GHz) making it impossible to achieve acceptable accuracy in the determination of the of water content.

Another known microwave method is based on a resonator cavity where the paper web is running through the cavity. The resonant frequency shift and the quality factor of the resonance are used to estimate the water content. This method offers no spatial resolution, and the sensor dimensions are relatively large and therefore difficult to integrate in a printing press.

In the IR part of the spectrum a known method based on reflected radiation at a wavelength of a couple of microns may be used. At this wavelengths the optical depth is very low (couple of microns). However, this technique cannot be used in transmission mode, and effects of scattering and vibrations in the paper web make the measurement more difficult. Moreover, this method measures water content only at the surface of the web.

For printing presses and their operation, the water content in the paper web before applying the ink is an important parameter. Too much water may result in unnecessary hydro expansion and compromised quality as a result of color misalignments. Therefore, there is a need for a compact and fast regulating system including an improved detecting unit that can be installed in existing printing unit lines to monitor and regulate the water content.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a system according to the appended claims.

An idea of the invention is to provide a system that enables measuring of the water content of a paper web running in a printing press.

A further idea of the invention is to provide a water content measuring system that is less expensive and less bulky than prior art systems.

A yet further idea is to provide a regulating system that may change the water content of the paper web after performing a measuring sequence on the moving paper web.

A still further idea is to provide an automatic system for optimizing the water content of a paper web in a printing press, thus optimizing the process and decreasing the required maintenance time.

As a result of considering the above mentioned drawbacks the inventors have come to the surprising conclusion that an improved measurement is achieved at frequencies where the paper thickness is a sizeable fraction of the wavelength. This part of the spectrum is often referred as mm (30-300 GHz), or sub-mm (300 GHz-3 THz). With a typical paper thickness between 50 μm and 100 μm the paper electrical thickness is about 1/9 of the wavelength at 300 GHz this results in attenuation/delay that are sensitive to the water content in the paper and at the same time convenient for measurement in transmission and/or reflection mode where the transmitter and the receiver are on the opposite and/or the same side of the paper. Another advantage of using the mm and sub-mm wavelengths is the possibility to fabricate compact optical components, resulting in compact sensor allowing positioning of the sensor almost at any point in the line.

The fact that minor differences of water in the paper produce measurable change in both amplitude and phase of the transmitted mm-wave signal can be used to provide two independent measurements of the same parameter (assuming the paper has a constant thickness) and further improve the accuracy of the measurement.

In summary, the advantage of using mm and sub-mm part of the spectra (100 GHz-3 THz) is that signals are significantly attenuated/delayed in proportion to the water content when transmitted through the thin paper layers (50-100 μm). At the microwave part of the spectra (<30 GHz) such thin layers become “invisible” since they represent a very small fraction of the wavelength whereas in the IR part of the spectra the paper thickness is optically “thick” and signals can not be transmitted through. As result effects of scattering and vibrations can affect the measurement.

According to a first aspect of the invention, a detecting unit for measuring properties of a paper web moving in a printing unit is provided comprising a transmitter arranged to emit electromagnetic radiation having a single wavelength in the range of 0.1 to 3 THz towards a paper web moving in a printing unit, a receiver arranged to receive electromagnetic radiation being transmitted through or reflected by said paper web and to create a signal proportional to the intensity and/or the delay of the received radiation, and a controller having an input channel for receiving the signal, and a calculating unit for determining a measure relating to the properties of the paper web from the signal.

According to a second aspect of the present invention, a method for detecting the water content of a moving paper web in a printing press is provided. The method comprises the steps of emitting electromagnetic radiation having a single wavelength in the range of 0.1 to 3 THz towards a paper web moving in a printing unit, receiving electromagnetic radiation being transmitted through or reflected by said paper web, creating a signal representing the received radiation, and determining a measure relating to the properties of the paper web from the signal.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a schematic view of a part of a general printing press, including a regulating system according to an embodiment of the present invention;

FIG. 2 is an absorption diagram showing the loss and refractive index of liquid water as a function of frequency;

FIGS. 3a and 3b are diagrams showing the attenuation and phase delay for 80 um thick paper for three different degrees of water content as a function of frequency;

FIG. 3c is a diagram showing the expected detection accuracy as a function of frequency of a detecting unit according to an embodiment;

FIGS. 4a to 4c are schematic side views of a detection system of a regulating system according to three embodiments;

FIG. 5 is a side view of a detection system of a regulating system according to a further embodiment of the present invention;

FIG. 6 is a cross sectional view of the detection system shown in FIG. 4; and

FIG. 7 is a schematic view of a control system including a detecting unit according to an embodiment.

### DESCRIPTION OF EMBODIMENTS

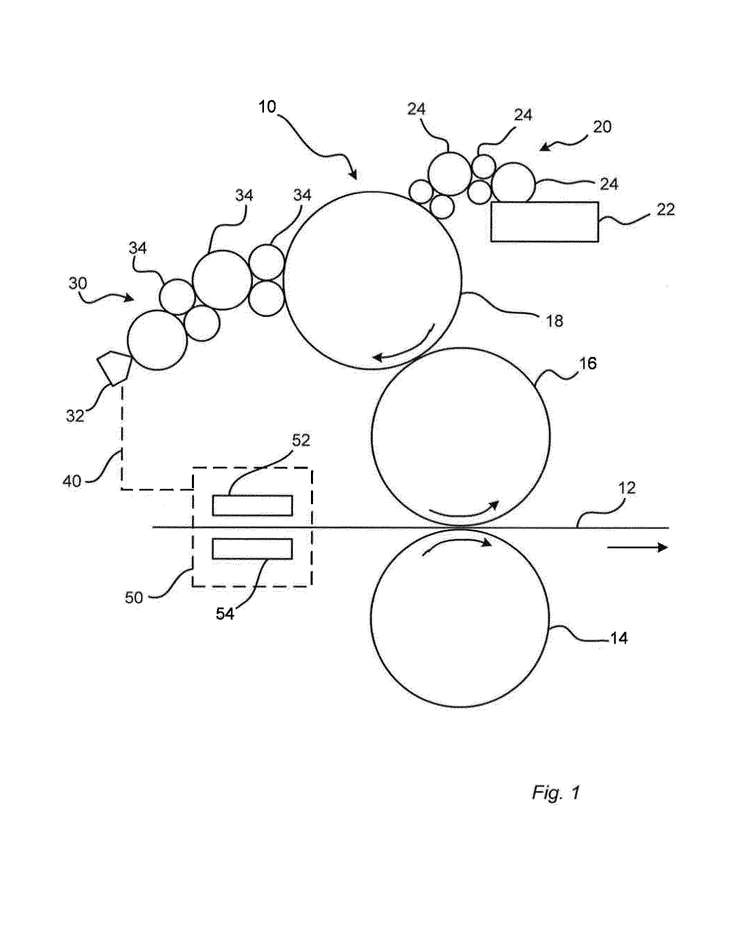

With reference to FIG. 1, a schematic view of a part 10 of printing press is shown. A paper web 12 is moving between an impression cylinder 14 and a rubber cylinder 16. Ink and a water based solution are fed to the rubber cylinder via a plate cylinder 18. Ink is provided by means of an ink supply 20 having an ink reservoir 22 and a sequence of rollers 24 arranged to smooth the thickness of the ink across the rollers such that the plate cylinder has a uniform thickness of ink across its length direction. Water based solution is provided in a similar manner by means of a supply 30 having a solution reservoir 32 and a number of rollers 34 arranged to smooth the thickness of the water based solution such that the plate cylinder 18 carries a uniform thickness of water based solution across its length direction.

The printing press may e.g. be an offset printer, and the plate cylinder 18 may thus carry a lithographic printing plate. The shown part 10 may e.g. be one of several stations of a printing press, of which each station is used and configured to provide a single color to the paper web 12.

The part 10 of the printing press has a regulating system 40 for adjusting the water content of the moving paper web 12. The regulating system 40 includes the supply 30 of the water based solution, a controller (not shown) for controlling the amount of water based solution provided to the paper web 12 via the cylinders 18, 14, and a detecting unit 50 configured to measure the water content of the moving paper web 12 and transmit the measured value of the water content to the controller. The controller then calculates if the supply 30 should increase the amount of water based solution that is provided to the paper web and consequently sends a command to the supply 30 if such action should be performed. The desired water content of the paper web, which normally is lower than 20%, is dependent on various parameters such as paper thickness and quality, press speed, desired color coverage etc.

In a further embodiment, the controller may also be connected to the ink supplying unit 20, for sending commands whether to increase or decrease the amount of ink due to the measured water content.

The detecting unit 50 comprises a transmitter 52 and a receiver 54. The transmitter 52 emits mm or sub-mm radiation, i.e. radiation in the range between 0.1 and 10 THz and preferably between 0.1 and 3 THz and the emitted radiation is collected by the receiver 54 after the radiation has interacted with the moving paper web 12.

In an embodiment, the emitted radiation has a single wavelength. However, the transmitter 52 may be capable of switching between radiation frequencies within the mm or sub-mm wavelength interval for improving accuracy of measurements.

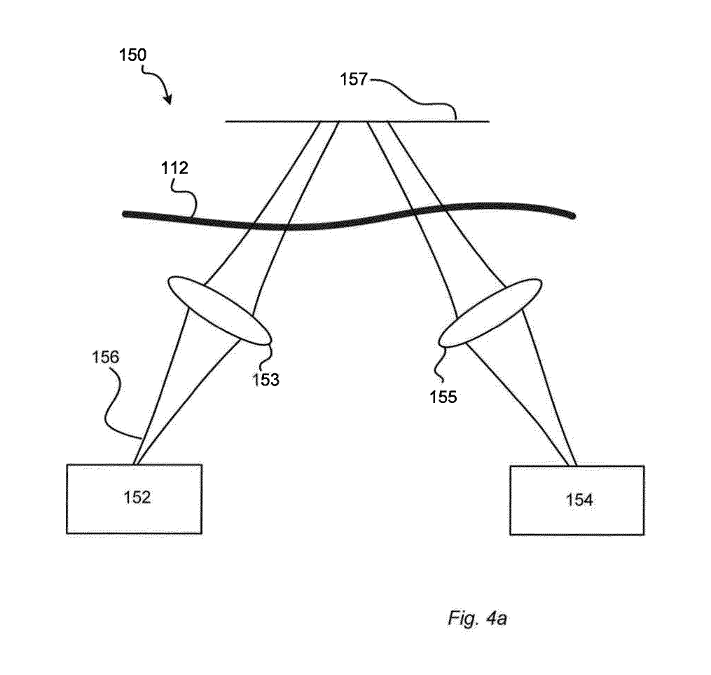

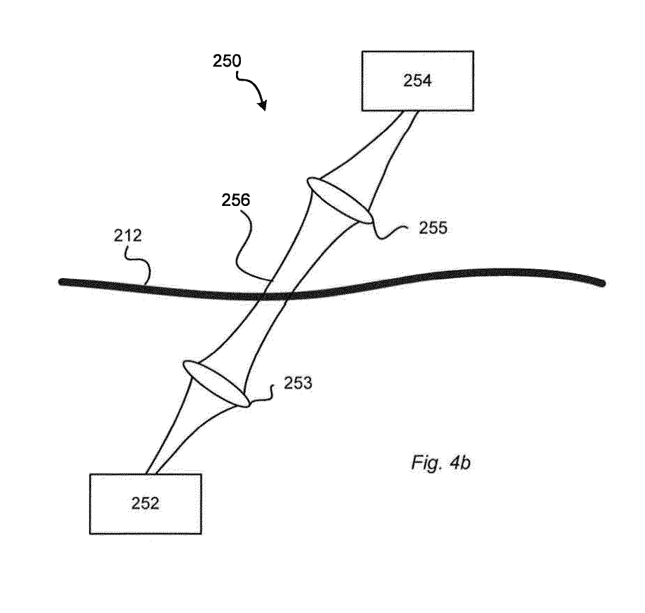

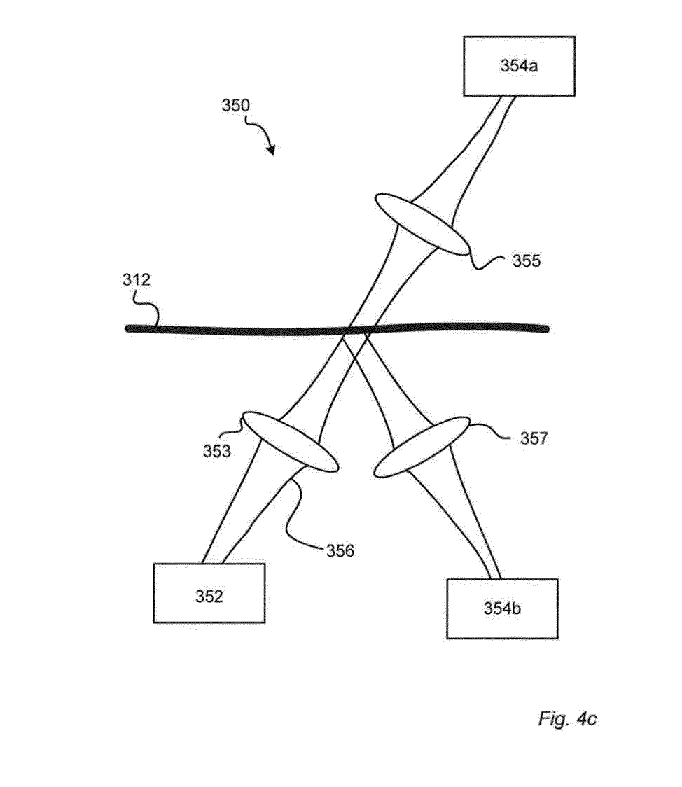

In one embodiment, as will be further described below with reference to FIG. 4a, the transmitter 52 and the receiver 54 are arranged on the same side of the paper web 12, and a reflector is arranged on the opposite side of the paper web 12. The transmitter 52 and the receiver 54 are arranged relative to the reflector such that the receiver 52 receives the radiation being transmitted through the paper web 12, reflected by the reflector, and again being transmitted through the paper web 12. In a further embodiment, as will be further described below with reference to

FIG. 4b, the transmitter 52 and the receiver 54 are arranged on opposite sides of the paper web 12, such that the receiver 54 detects radiation that has been propagating through the paper web 12. Hence, the detecting system may be configured to operate in transmission mode.

In another embodiment, as will be further described below with reference to FIG. 4c, two receivers are arranged on both sides of the paper web, such that the receivers detects radiation that has been reflected as well as transmitted by the moving paper web 12.

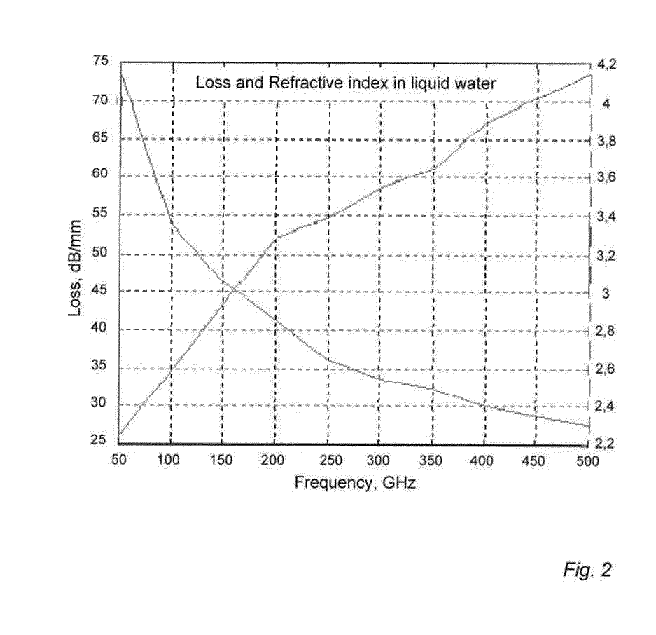

The presented embodiments take advantage of frequencies between 100 GHz and 10 THz, preferably between 0.1 and 3 THz, and even more preferably between 0.1 and 1 THz. Frequencies in this range are strongly attenuated by water, 52 dB/mm at 200 GHz and 75 dB/mm at 500 GHz, which means that a particular good resolution may be obtained using these wavelengths. As a comparison, the paper itself is almost transparent to said electromagnetic radiation. The water attenuation is shown in FIG. 2, which is an absorption diagram published in Infrared Intensities of Liquids XX: The Intensity of the OH Stretching Band of Liquid Water Revisited, and the Best Current Values of the Optical Constants of H20(1) at 25° C. between 15,000 and 1 cm−1, John E. Bertie and Zhida Lan, Applied Spectroscopy, Vol. 50, Issue 8, pp. 1047-1057 (1996).

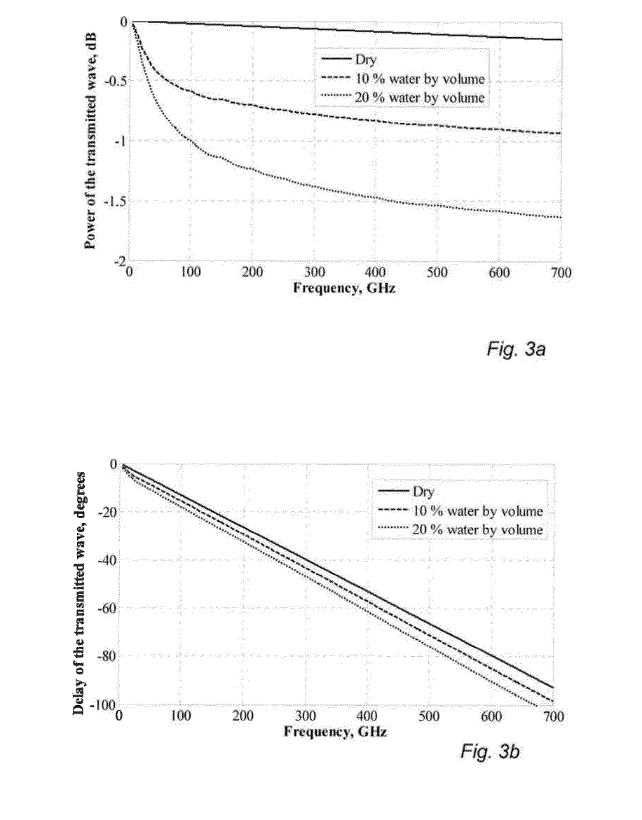

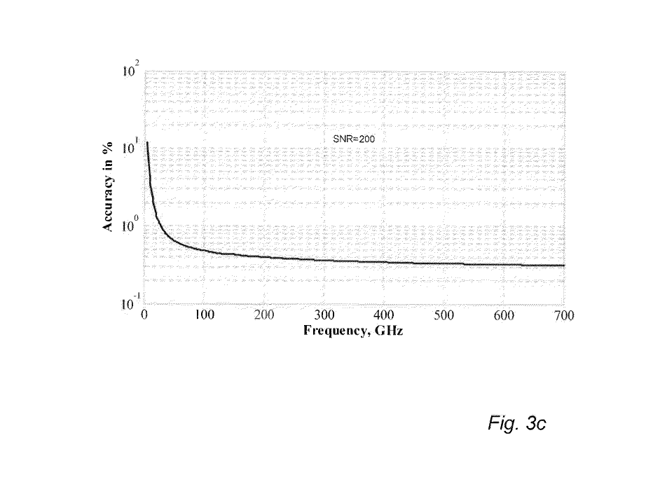

With further reference to FIGS. 3a and 3b, theoretical plots of attenuation and phase delay for a 80 μm thick paper for three different grades of water content are shown. Further, expected accuracy of a system based on amplitude-only measurement of a transmitted signal through the paper is shown in FIG. 3c. The calculation is for signal to noise ratio of 200 and 80 μm thick paper; accuracy of 0.3% is expected at 300 GHz.

At the same time, emitters and detectors/receivers can be produced and manufactured at a reasonable price and with compact dimensions.

The THz transmitter 52 may be implemented by using a commercially available and cost effective oscillator, such as a voltage controlled oscillator or a dielectric resonance oscillator, and multiply the output frequency by a predetermined number of times. Using the suggested frequencies, focusing is convenient resulting in compact sensor pixels. For example, focusing of the radiation in the described setup may be done by a pair of Teflon lenses or mirrors, each having a diameter of 3 to 8 cm. The irradiated surface of the paper may thus be a couple of millimeters up to a decimeter in diameter.

For the proposed frequencies, i.e. 0.1 to 3 THz, the corresponding wavelength is larger than the surface irregularities as well as the paper thickness which makes it possible to transmit radiation through the paper web while scattering effects and vibrations have negligible effect on the accuracy of the measurement. When the detecting unit operates in transmission mode, measuring of the total water content in the paper web is thus possible.

According to an embodiment, a detecting unit for determining properties of a paper web moving in a printing press is thus provided comprising a transmitter, a receiver, and a controller.

An embodiment of a detecting unit 150 is shown in FIG. 4a. Here, the transmitter 152 and the receiver 154 are located on the same side of the paper to be irradiated. The THz radiation 156 passes through a focusing component 153, before it reaches the paper 112 to be analyzed. A mirror 157 is arranged on the opposite side of the paper 112 and reflects the transmitted radiation 156 at a reflection angle, such that the reflected radiation 156 is again transmitted through the paper web 112, passes through a focusing component 155, before it is collected by the receiver 154.

Another embodiment of a detecting unit 250 is shown in FIG. 4b. Here, the transmitter 252 and the receiver 254 are located on opposite sides of the paper to be irradiated. The THz radiation 256 passes through a focusing component 253, before it reaches the paper 212 to be analyzed. When the radiation 256 is transmitted through the paper web 212, it will pass through a second focusing component 255, before it is collected by the receiver 254. Such configuration is preferably used when water content of a paper, having a known thickness, is to be determined. This may be done by measuring the amplitude of the transmitted radiation. If phase measurements are included, the paper thickness of the paper may also be determined. Hence, the amplitude as well as the phase shift of the detected signal carries information about the paper thickness as well as water content. If one variable is unknown it is thus sufficient to detect only one parameter, while two parameters are necessary in order to determine both thickness and water content of the paper, or can be used to provide two different measures of the water content assuming constant paper thickness.

The embodiments shown in FIGS. 4a and 4b are preferably used for detecting water content in optically thin paper webs. This means that the paper thickness is substantially thinner than the wavelength of the transmitted radiation, e.g. by a factor 5 to 20. Hence, the presented detector units are advantageous in that they provide transmission measurements with good sensitivity to water, while they are insensitive to paper orientation and surface irregularities.

In a yet further embodiment (not shown), the transmitter and the receiver may be arranged to operate in reflection mode. Such kind of setup, requiring that the transmitter and receiver are arranged on the same side of the paper web such that the receiver collects radiation being reflected by the paper web, is preferably utilized when the water content of optically thick paper webs is to be measured.

The detecting unit is able to perform remote and contact free measurements of the water content and the thickness of a moving paper web by emitting coherent THz radiation and focus it on one side of a paper web 12 running in a printing press. The emerging radiation on the other side of the paper web 12 may be focused on a receiver 54 which measures the magnitude and phase of the transmitted signal being attenuated and delayed in proportion to the water content and the thickness of the paper web 12. Hence, both the water content and the thickness of the paper web 12 may be extracted from the measurement and used as an input for the water base solution supply.

Since the system provides transmission through the paper web 12 the measured magnitude and phase is not affected by the angle at which the radiation is incident on the paper web 12. This results in an even more robust system where vibrations do not contaminate the measurement. A further advantage of a transmission based system is that the wavelength is larger than the surface irregularities, leading to no decrease of the inaccuracy of the measurement due to scattering effects.

A further embodiment of a detecting unit 350 is shown in FIG. 4c. Here, a combination of reflection mode and transmission mode is implemented for achieving a measurement corresponding to the water content of the paper web 312. A transmitter 352 is located at a first side of the paper web 312, and a first receiver 354a is located on the opposite side of the paper to be irradiated for measuring the radiation being transmitted through the paper web 312. A second receiver 354b is arranged on the same side of the paper web 312 as the transmitter 352 at a position such that the second receiver 354b detects radiation being reflected by the paper web 312. During measurements, the THz radiation 356 passes through a focusing component 353 before it reaches the paper 312 to be analyzed. A portion of the radiation 356 is transmitted through the paper web 312, and it will pass through a second focusing component 355, before it is collected by the first receiver 354a. Another portion of the radiation 356 is reflected by the paper web 312, and it will pass through a third focusing component 357 before it is collected by the second receiver 354b. Such unit 350 is advantageous in that both thickness and water content may be determined by detecting amplitude only. Hence, the receivers 354a, 354b may be amplitude detectors.

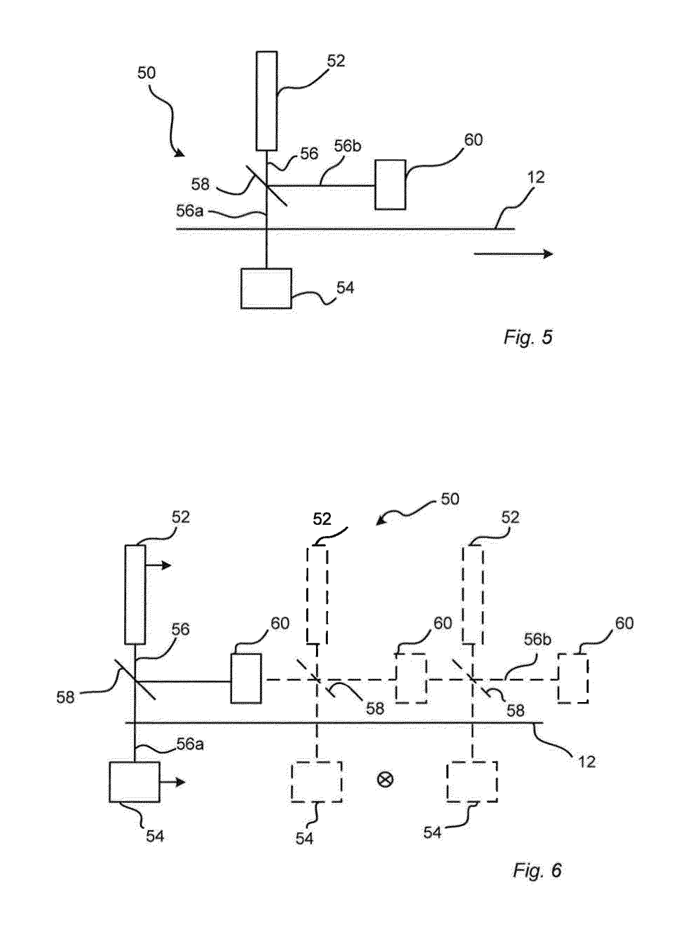

With reference to FIG. 5, a side view of a detecting unit 50 is schematically shown. The detecting unit 50 is arranged to measure the water content of a moving paper web 12 running in a printing unit. The detecting unit 50 includes a THz emitter 52 capable of emitting a beam 56 of THz radiation. The unit 50 further includes a receiver 54 for detecting the beam 56 after being transmitted through the paper web 12, and a second receiver 60 which is arranged to receive a reference signal. The two-sensor setup is enabled by providing a beam splitter 58 which allows a first part 56a of the beam 56 to be transmitted through the paper web 12, and a second part 56b of the beam 56 to propagate directly to the reference receiver 60.

The accuracy of the measurement is thus improved, since the signal transmitted through the paper web is compared to another signal detected by the reference receiver 60, which signal is fed by the same source 52 without being transmitted through the paper web. Drift in the source power and/or frequency may thus be calibrated out from the measurement. For such measurement, the receivers 54, 60 are connected to a controller (not shown) configured to convert the measured values to actual properties of the paper web. Hence, the control may have a memory in which reference values are stored corresponding to such actual properties.

The distance between the transmitter 52 and the receiver 54 is preferably in the order of 10 cm. Hence, effects such as atmospheric humidity will affect the signal only to a very little extent. There are a number of gas lines in the atmosphere where the absorptions peaks, as for example the 183 GHz water line. In the table below, examples of absorption vs. frequency and humidity are given. Even if the transmitter operates at 183 GHz (which is considered as a worst case) the attenuation will change from 15 dB/km to 48 dB/km for humidity rise from 30% to 100%. For a 15 cm path this will introduce 0.005 dB extra loss. On the other hand, if the transmitter is operating at 220 GHz the extra loss will only be 0.0005 dB.

| | |
|---|---|
| | Absorption (dB/km) for Relative Humidity (%) |
| Frequency | (for 1013 hPa pressure and temperature of 20° C.) |

| (GHz) | 30% | 60% | 100% |
|---|---|---|---|
| 150 | 0.51 | 1.1 | 2.07 |
| 183 | 15 | 29.56 | 47.93 |
| 220 | 1.1 | 2.42 | 4.52 |

In FIG. 6, a cross sectional view of the detecting unit 50 of FIG. 5 is shown. Here, the detecting unit 50 is connected to a translation stage (not shown) being capable of moving the detecting unit 50 along the width of the paper web 12. Hence, the detecting unit is capable of measuring the water content at different lateral positions along the paper web 12. In this particular embodiment, the transmitter 52, the splitter 58, the receiver 54, and the reference sensor 60 are all connected to the translation stage.

For example, the beam splitting may be done by having a semi-transparent film, i.e. having optical coupling between the transmitter 52 and the reference sensor 60. In this case, the distance between the transmitter 52 and the reference sensor 60 should be held constant. However, the transmitter 52 may also be coupled mechanically to the reference sensor 60 by means of a waveguide directional coupler.

In a yet further embodiment, a number of detecting units 50 may be stationary positioned along the width of the paper web 12, thus reducing the need for a translation stage moving the components of the unit(s). In some embodiments, it may be desired to have a number of fixed detecting units disposed laterally across the paper web width. An increased number of units may thus provide increased lateral resolution, although the overall complexity of the system is increased. By using the described THz radiation, i.e. electromagnetic radiation in the range of 0.1 to 3 THz, each unit may be relatively small, e.g. having a width and depth of approximately 10 cm. The height of each unit is somewhat larger in order to provide enough space for the optical components. Hence it is possible to arrange up to ten detection units adjacent to each other for covering one meter of paper web width.

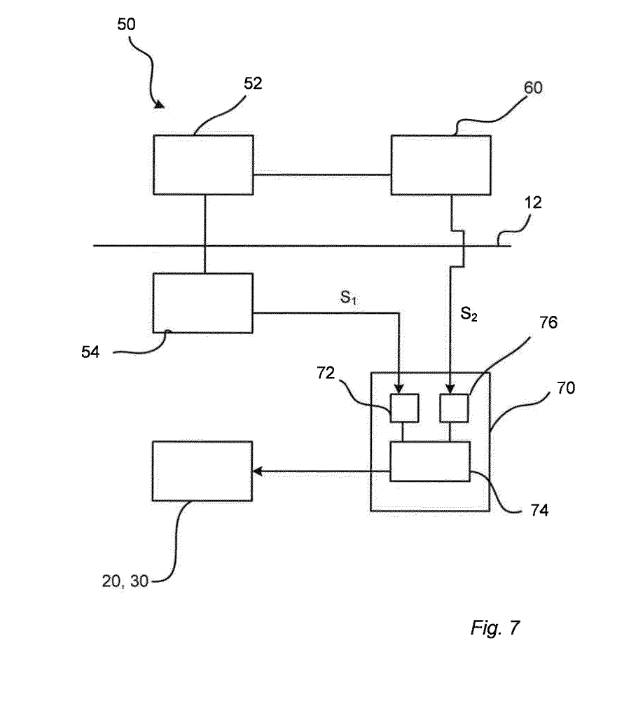

With reference to FIG. 7, a schematic view of a detecting unit 50 is shown. The unit 50 includes the transmitter 52, the receiver 54, the reference sensor/receiver 60, and the controller 70. The controller 70 has an input channel 72 which is configured to receive a signal S1 from the receiver 54, wherein the signal S1 is representing the received THz radiation with respect to magnitude and phase after being transmitted through the paper web 12. Further, a calculator 74 is provided being programmed to calculate the water content of the paper web 12 from the signal S1. For further increasing the accuracy of the measurements, the reference sensor 60 provides a signal S2 to the controller via a second input channel 76. The signal S2 contains phase and amplitude reference information of the emitted radiation. The calculator 74 then determines the water content by comparing the signals S1 and S2 to each other, and the difference is then matched to pre-stored reference values corresponding to the absorption spectrum of the water based solution currently used in the printing unit.

The calculator 74 is further programmed to create a command which may be sent to either the ink supply 20, the water based solution supply 30, or both. Hence, the command will correspond to a request for increased or decreased supply of either ink or water based solution, e.g. in order to maintain minimum ink flow and improve the printing quality of the press.

The presented embodiments fill a gap in the existing methods for measurement of water content in thin paper layers. The existing systems for measuring water content are either too bulky, and thus not well-matched for installation on existing printing units, or not suited for thin paper layers.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way. Further, any reference to “upper”, “lower”, “right”, or “left” are made only as relative determinations. It should thus be realized that such references do not limit the scope of the claims.

1. A detecting unit for measuring properties of a paper web moving in a printing unit, comprising:
a transmitter arranged to emit electromagnetic radiation, having a frequency in the range of 0.1 to 10 THz, towards the paper web moving in the printing unit;
a receiver, arranged to receive electromagnetic radiation being transmitted through or reflected by said paper web and to create a signal representing the received radiation; and
a controller, having including an input channel for receiving the signal, and a calculating unit for determining a measure relating to the properties of the paper web from the signal.

2. The detecting unit of claim 1, wherein the determined measure is a value representing the water content of the paper web.

3. The detecting unit of claim 1, wherein the signal comprises information regarding at least one of the magnitude and the phase of the received electromagnetic radiation.

4. The detecting unit of claim 1, wherein the controller further comprises an output channel for transmitting a command to a fluid supply of said printing unit, said command being determined from the determined measure.

5. The detecting unit of claim 4, wherein said fluid supply is configured to provide water based solution to the paper web.

6. The detecting unit of claim 4, wherein said fluid supply is configured to provide ink to the paper web

7. The detecting unit of claim 1, further comprising a second receiver arranged to receive electromagnetic radiation emitted from said transmitter but not having been transmitted through or reflected by the paper web.

8. The detecting unit of claim 7, wherein the controller further comprises a second input channel for receiving a reference signal representing the magnitude and the phase of the electromagnetic radiation received by said second receiver, and wherein the calculating unit is configured to determine the measure relating to the properties of the paper web from both signals.

9. The detecting unit of claim 1, wherein the distance between the transmitter and the receiver is less than 15 cm.

10. The detecting unit of claim 1, wherein the emitted radiation has a fixed frequency in the range of 0.1 to 10 THz.

11. A method for detecting the water content of a moving paper web in a printing unit, comprising:
emitting electromagnetic radiation having a frequency in the range of 0.1 to 10 THz towards the paper web moving in the printing unit;
receiving electromagnetic radiation being transmitted through or reflected by said paper web;
creating a signal representing the received radiation; and
determining a measure relating to the properties of the paper web from the signal.
